(19) United States
(12) Patent Application Publication
(10) Pub. No.: US 2019/0054775 A1
(43) Pub. Date: Feb. 21, 2019

(54) TREAD FOR A PNEUMATIC TIRE

(71) Applicant: The Goodyear Tire & Rubber Company, Akron, OH (US)

(72) Inventors: Philippe Joseph Auguste MULLER, Champlon (BE); Jung Wan CHO, Hudson, OH (US); Sebastien PENIN, Schieren (LU); William Urbano VILLAMIZAR, Mersch (LU); Franck TUCCELLA, Lexy (FR)

(21) Appl. No.: 15/679,242

(22) Filed: Aug. 17, 2017

(51) Int. Cl. B60C 11/13; B60C 11/03; B60C 11/12

(52) U.S. Cl. CPC B60C 11/1307; B60C 11/1204; B60C 11/0306

(57) ABSTRACT

A pneumatic tire includes a first circumferential groove extending in a circumferential direction of the pneumatic tire, a second circumferential groove extending in the circumferential direction of the pneumatic tire, a third circumferential groove extending in the circumferential direction of the pneumatic tire; and a fourth circumferential groove extending in the circumferential direction of the pneumatic tire, the first, second, third, and fourth circumferential grooves defining first, second, third, fourth, and fifth ribs. Each of the ribs includes lateral grooves and lateral sipes. The lateral grooves of the first rib each having chamfers on an upper side at an intersection with the first circumferential groove.

### FIELD OF INVENTION

The present invention relates to an all-season pneumatic tire with an improved tread, and more particularly, relates to a pneumatic tire tread having improved stiffness and more uniform footprint pressure distribution.

### BACKGROUND OF THE INVENTION

Conventionally, in addition to circumferential main grooves and lateral grooves, pneumatic tire treads may have sipes on a tread surface in order to demonstrate favorable functional characteristics (e.g., low rolling resistance, good traction, good durability, etc.).

The following definitions are controlling for the disclosed invention.

“Axial” and “Axially” means the lines or directions that are parallel to the axis of rotation of the tire.

“Axially Inward” means in an axial direction toward the equatorial plane.

“Axially Outward” means in an axial direction away from the equatorial plane.

“Bead” or “Bead Core” generally means that part of the tire comprising an annular tensile member of radially inner beads that are associated with holding the tire to the rim.

“Belt Structures” or “Reinforcement Belts” or “Belt Package” means at least two annular layers or plies of parallel cords, woven or unwoven, underlying the tread, unanchored to the bead, and having both left and right cord angles in the range from 18 degrees to 30 degrees relative to the equatorial plane of the tire.

“Carcass” means the tire structure apart from the belt structure, tread, undertread over the plies, but including the beads.

“Circumferential” most often means circular lines or directions extending along the perimeter of the surface of the annular tread perpendicular to the axial direction; it can also refer to the direction of the sets of adjacent circular curves whose radii define the axial curvature of the tread, as viewed in cross section.

“Directional Tread Pattern” means a tread pattern designed for specific direction of rotation.

“Equatorial Plane” means the plane perpendicular to the tire's axis of rotation and passing through the center of its tread; or the plane containing the circumferential centerline of the tread.

“Footprint” means the contact patch or area of contact of the tire tread with a flat surface under normal load pressure and speed conditions.

“Groove” means an elongated void area in a tread that may extend circumferentially or laterally in the tread in a straight, curved or zigzag manner It is understood that all groove widths are measured perpendicular to the centerline of the groove.

“Lateral” means a direction going from one sidewall of the tire towards the other sidewall of the tire.

“Net to gross” means the ratio of the net ground contacting tread surface to the gross area of the tread including the ground contacting tread surface and void spaces comprising grooves, notches and sipes.

“Notch” means a void area of limited length that may be used to modify the variation of net to gross void area at the edges of blocks.

“Ply” means a cord-reinforced layer of rubber coated radially deployed or otherwise parallel cords.

“Radial” and “radially” mean directions radially toward or away from the axis of rotation of the tire.

“Radial Ply Tire” means a belted or circumferentially-restricted pneumatic tire in which at least one ply has cords which extend from bead to bead are laid at cord angles between 65 degrees and 90 degrees with respect to the equatorial plane of the tire.

“Shoulder” means the upper portion of sidewall just below the tread edge.

“Sidewall” means that portion of a tire between the tread and the bead.

“Sipe” means a groove having a width in the range of 0.2% to 0.8% of the tread width. Sipes are typically formed by steel blades having a 0.4 to 1.6 mm, inserted into a cast or machined mold.

“Tangential” and “Tangentially” refer to segments of circular curves that intersect at a point through which can be drawn a single line that is mutually tangential to both circular segments.

“Tread” means the ground contacting portion of a tire.

“Tread width” (TW) means the greatest axial distance across the tread, when measured (using a footprint of a tire,) laterally from shoulder to shoulder edge, when mounted on the design rim and subjected to a specified load and when inflated to a specified inflation pressure for said load.

“Void Space” means areas of the tread surface comprising grooves, notches and sipes.

### SUMMARY OF THE INVENTION

A pneumatic tire in accordance with the present invention includes a first circumferential groove extending in a circumferential direction of the pneumatic tire, a second circumferential groove extending in the circumferential direction of the pneumatic tire, a third circumferential groove extending in the circumferential direction of the pneumatic tire; and a fourth circumferential groove extending in the circumferential direction of the pneumatic tire, the first, second, third, and fourth circumferential grooves defining first, second, third, fourth, and fifth ribs. Each of the ribs includes lateral grooves and lateral sipes. The lateral grooves of the first rib each having chamfers on an upper side at an intersection with the first circumferential groove.

According to another aspect of the pneumatic tire, the lateral grooves of the second rib each have chamfers on a lower side at an intersection with the first circumferential groove, the lower side of the second rib being circumferentially opposite the upper side of the first rib.

According to still another aspect of the pneumatic tire, the lateral grooves of the second rib each have chamfers on an upper side at an intersection with the second circumferential groove, the upper side of the second rib being circumferentially opposite the lower side of the second rib.

According to yet another aspect of the pneumatic tire, the lateral grooves of the third rib each have chamfers on an upper side at an intersection with the second circumferential groove, the upper side of the third rib being circumferentially equivalent to the upper side of the second rib.

According to still another aspect of the pneumatic tire, the lateral grooves of the third rib each have chamfers on a lower side at an intersection with the third circumferential groove, the lower side of the third rib being circumferentially opposite the upper side of the third rib.

According to yet another aspect of the pneumatic tire, the lateral grooves of the fourth rib each have chamfers on a lower side at an intersection with the third circumferential groove, the lower side of the fourth rib being circumferentially equivalent the lower side of the third rib.

According to still another aspect of the pneumatic tire, the lateral grooves of the fourth rib each have chamfers on an upper side at an intersection with the fourth circumferential groove, the upper side of the fourth rib being circumferentially opposite the lower side of the fourth rib.

According to yet another aspect of the pneumatic tire, the lateral grooves of the fifth rib each have chamfers on a lower side at an intersection with the fourth circumferential groove, the lower side of the fifth rib being circumferentially opposite the upper side of the fourth rib.

A tread for a pneumatic tire in accordance with the present invention includes a first circumferential groove extending in a circumferential direction of the pneumatic tire, a second circumferential groove extending in the circumferential direction of the pneumatic tire, a third circumferential groove extending in the circumferential direction of the pneumatic tire, and a fourth circumferential groove extending in the circumferential direction of the pneumatic tire. The first, second, third, and fourth circumferential grooves define first, second, third, fourth, and fifth ribs. Each of the ribs includes lateral grooves and lateral sipes extending across each rib. The lateral grooves of the first rib each have chamfers on an upper side at an intersection with the first circumferential groove. The lateral sipes of the third rib each have crimped portions both where the sipes intersect the second groove and where the sipes intersect the third groove.

According to another aspect of the tread, the lateral grooves of the second rib each have chamfers on a lower side at an intersection with the first circumferential groove, the lower side of the second rib being circumferentially opposite the upper side of the first rib.

According to still another aspect of the tread, the lateral grooves of the second rib each have chamfers on an upper side at an intersection with the second circumferential groove, the upper side of the second rib being circumferentially opposite a lower side of the second rib.

According to yet another aspect of the tread, the lateral grooves of the third rib each have chamfers on an upper side at an intersection with the second circumferential groove, the upper side of the third rib being circumferentially equivalent to an upper side of the second rib.

According to still another aspect of the tread, the lateral grooves of the third rib each have chamfers on a lower side at an intersection with the third circumferential groove, the lower side of the third rib being circumferentially opposite an upper side of the third rib.

According to yet another aspect of the tread, the lateral grooves of the fourth rib each have chamfers on a lower side at an intersection with the third circumferential groove, the lower side of the fourth rib being circumferentially equivalent a lower side of the third rib.

According to still another aspect of the tread, the lateral grooves of the fourth rib each have chamfers on an upper side at an intersection with the fourth circumferential groove, the upper side of the fourth rib being circumferentially opposite a lower side of the fourth rib.

According to yet another aspect of the tread, the lateral grooves of the fifth rib each have chamfers on a lower side at an intersection with the fourth circumferential groove, the lower side of the fifth rib being circumferentially opposite an upper side of the fourth rib.

According to still another aspect of the tread, each of the lateral sipes of both the first and fifth ribs are blind sipes.

### BRIEF DESCRIPTION OF THE DRAWINGS

The present invention will be more clearly understood by the following description of some examples thereof, with reference to the accompanying drawings, in which:

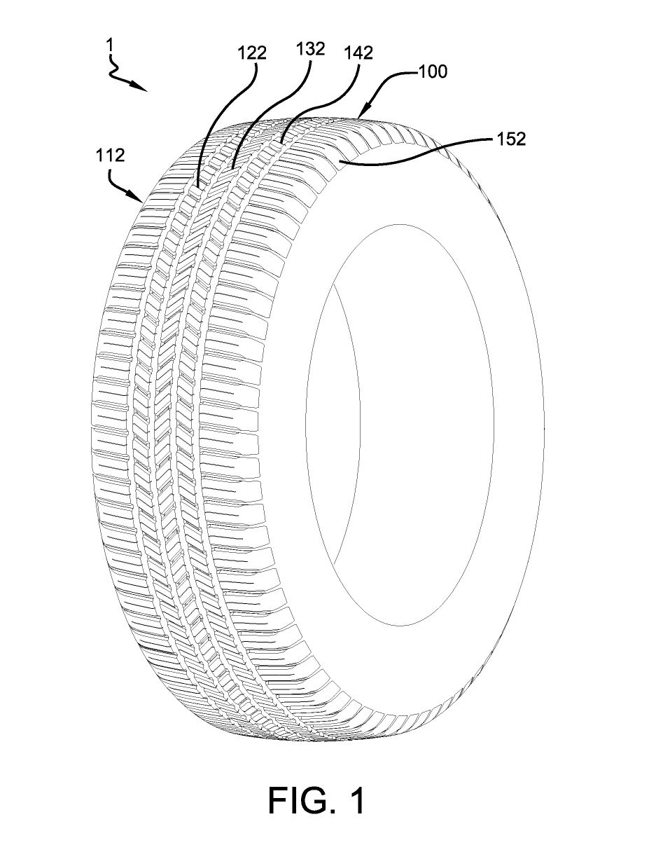

a. FIG. 1 is a schematic perspective view of a pneumatic tire having a tread pattern in accordance with the present invention.

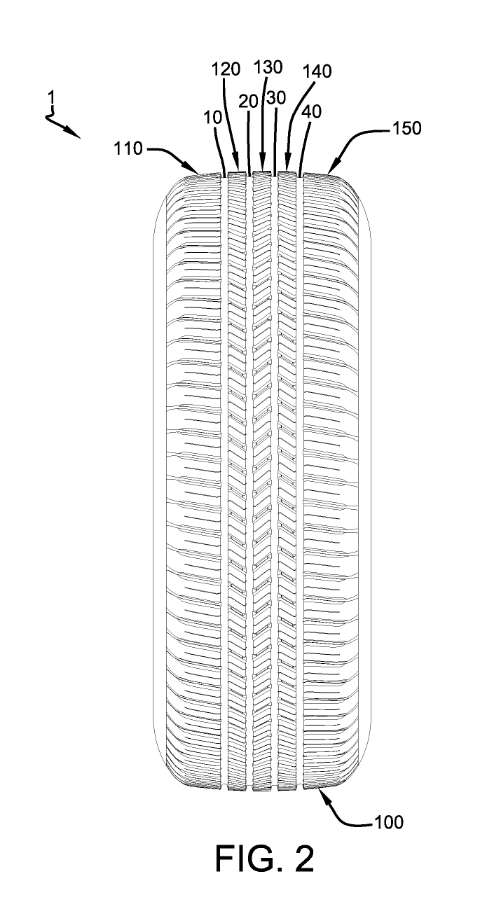

b. FIG. 2 is a schematic orthogonal front view of the pneumatic tire and tread pattern of FIG. 1.

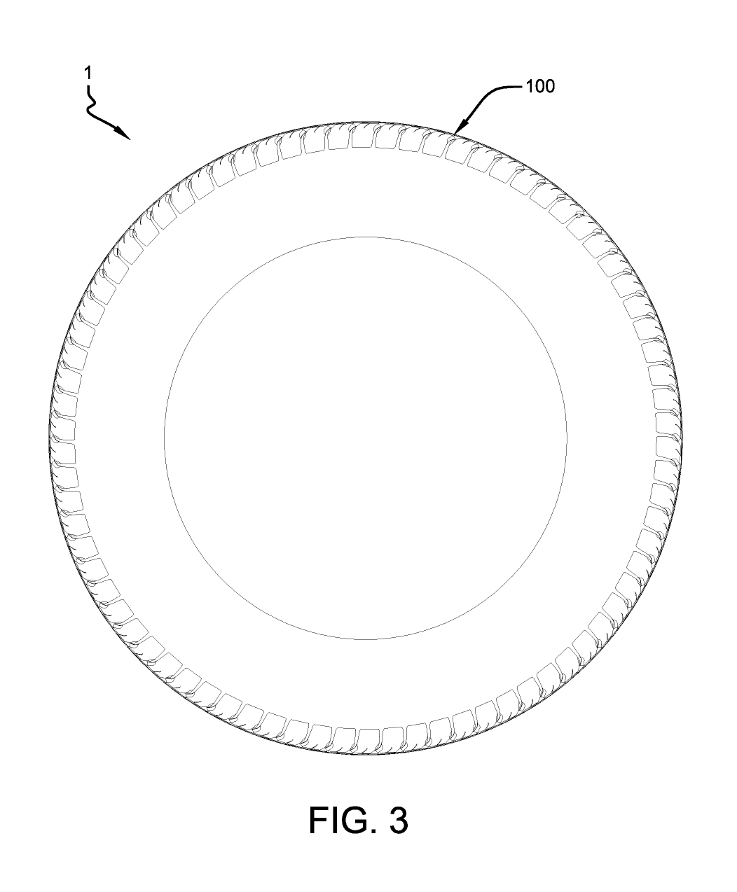

c. FIG. 3 is a schematic orthogonal side view of the pneumatic tire and tread pattern of FIG. 1.

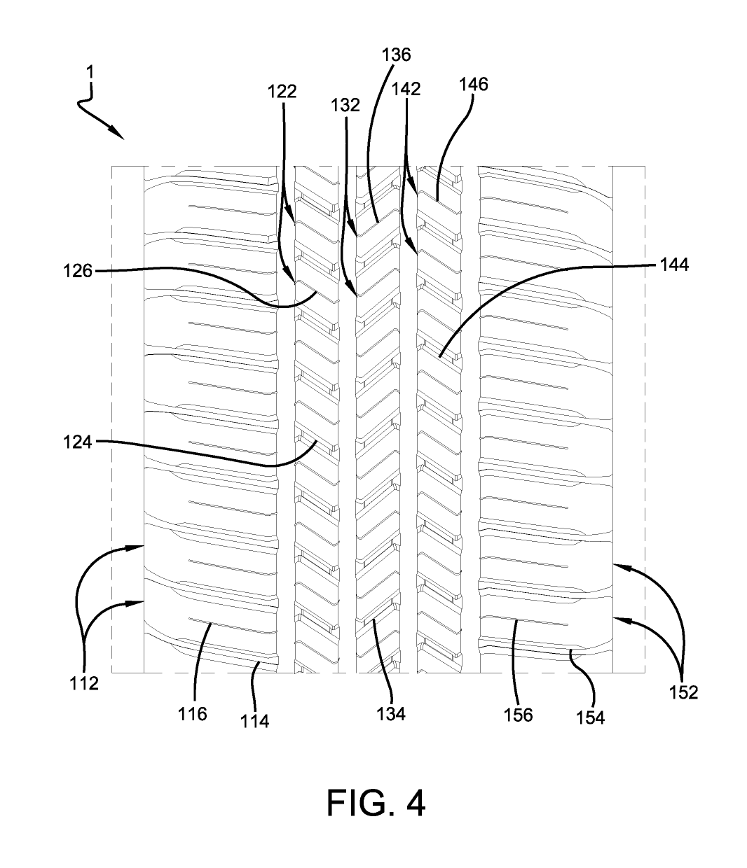

d. FIG. 4 is a schematic orthogonal detail view of the tread pattern of FIG. 1.

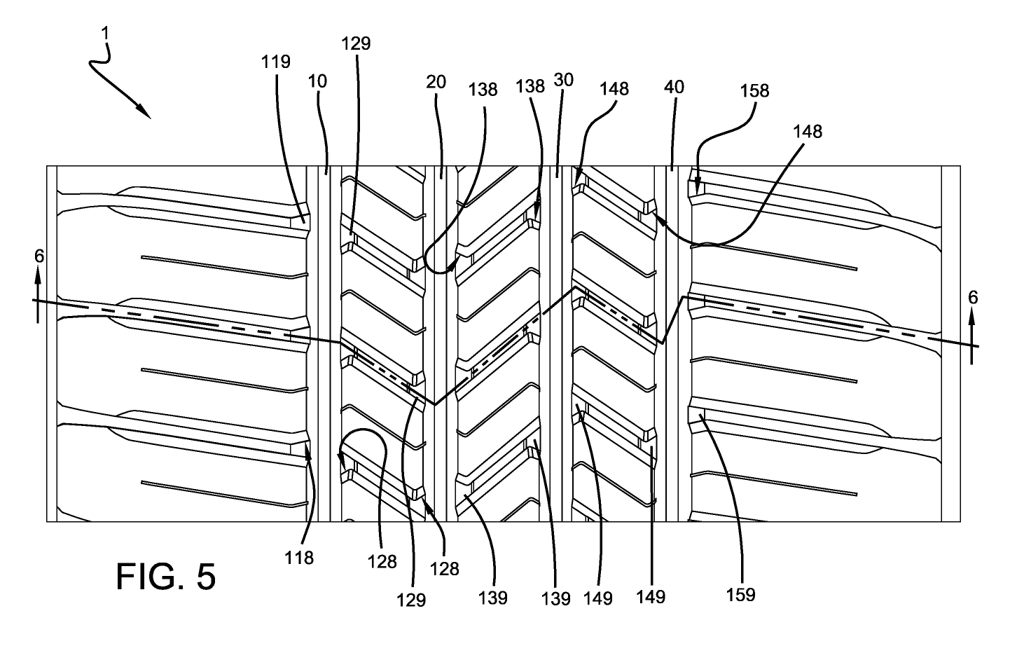

e. FIG. 5 is a magnified schematic orthogonal detail view of the detail of FIG. 4.

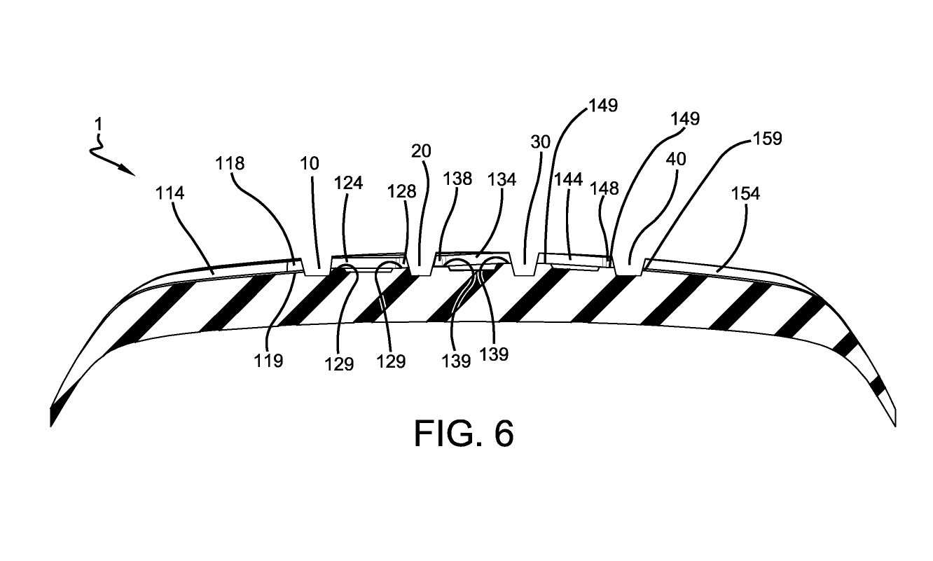

f. FIG. 6 is a schematic sectional view taken along line 6-6 in FIG. 5.

### DESCRIPTION OF EXAMPLES OF THE PRESENT INVENTION

A pneumatic tire 1 in accordance with the present invention may include a tread 100 with a first main circumferential groove 10, a second main circumferential groove 20, a third main circumferential groove 30, and a fourth main circumferential groove 40 all extending in a circumferential direction C of the pneumatic tire forming the tread 100. Five land portions, or ribs 110, 120, 130, 140, 150 may be formed by these main circumferential grooves 10, 20, 30, 40. Each of the ribs 110, 120, 130, 140, 150 may have additional grooves and sipes extending laterally L and/or circumferentially C across the ribs 110, 120, 130, 140, 150 forming discreet and circumferentially repeating blocks, or tread elements 112, 122, 132, 142, 152. The main circumferential grooves 10, 20, 30, 40 may have, for example, a lateral width between 3.0 mm and 20.0 mm and an example radial depth between 5.0 mm and 13.0 mm

The first shoulder rib 110 may have alternating lateral grooves 114 and lateral blind sipes 116 extending axially and at a slight angle from the main circumferential groove 10 axially toward the outer edge of the tread 100. The lateral grooves 114 may have chamfers 118 on an upper side (as viewed in FIG. 4) at their intersection with the first main circumferential groove 10. The bottom of the lateral grooves 114 may have humps or approximately 2.0 mm steps 119 at each chamfer 118. The second shoulder rib 150 may have alternating lateral grooves 154 and lateral blind sipes 156 extending axially and at a slight angle from the main circumferential groove 40 axially toward the outer edge of the tread 100. The lateral grooves 154 may have chamfers 158 on a lower side (as viewed in FIG. 4) at their intersection with the fourth main circumferential groove 40. The bottom of the lateral grooves 154 may have humps or approximately 2.0 mm steps 159 at each chamfer 158.

The three center main circumferential ribs 120, 130, 140 may have alternating angled grooves 124, 134, 144 and angled sipes 126, 136, 146 extending axially and circumferentially across the ribs 120, 130, 140 between the corresponding main circumferential grooves 10, 20, 30, 40. As shown in FIGS. 2 and 4, the grooves 124, 144 and sipes 126, 146 of the outer ribs 120, 140 may extend at equal angles while the grooves 134 and sipes 136 of the center rib 130 may extend at an equal, but opposite, angle compared to the angle of the ribs 120, 140.

The angled grooves 124 of the first intermediate rib 120 may have chamfers 126 on a lower side (as viewed in FIG. 4) at their intersection with the first main circumferential groove 10. The angled grooves 124 of the first intermediate rib 120 may further have chamfers 128 on an upper side (as viewed in FIG. 4) at their intersection with the second main circumferential groove 20. The bottom of the lateral grooves 124 may have humps or approximately 2.0 mm steps 129 at each chamfer 128.

The angled grooves 134 of the center rib 130 may have chamfers 136 on an upper side (as viewed in FIG. 4) at their intersection with the second main circumferential groove 20. The angled grooves 134 of the center rib 130 may further have chamfers 138 on a lower side (as viewed in FIG. 4) at their intersection with the third main circumferential groove 30. The bottom of the lateral grooves 134 may have humps or approximately 2.0 mm steps 139 at each chamfer 138.

The angled grooves 144 of the second intermediate rib 140 may have chamfers 146 on a lower side (as viewed in FIG. 4) at their intersection with the third main circumferential groove 30. The angled grooves 144 of the second intermediate rib 140 may further have chamfers 148 on an upper side (as viewed in FIG. 4) at their intersection with the fourth main circumferential groove 40. The bottom of the lateral grooves 144 may have humps or approximately 2.0 mm steps 149 at each chamfer 148.

Each of the angled sipes 126, 136, 146 of the center rib 130 and the intermediate ribs 120, 140 and the shoulder sipes 116, 156 of the shoulder ribs 110, 150 may have angled crimps 117, 127, 137, 147, 157 at each end adjacent one of the main circumferential grooves 10, 20, 30, 40. Along the first main circumferential groove 10, the shoulder sipes 116 may be crimped upward (as viewed in FIG. 4) and the angled sipes 126 may be crimped downward (as viewed in FIG. 4). Along the second main circumferential groove 20, the angled sipes 126 may be crimped upward (as viewed in

FIG. 4) and the angled sipes 136 may be crimped downward (as viewed in FIG. 4). Along the third main circumferential groove 30, the angled sipes 136 may be crimped downward (as viewed in FIG. 4) and the angled sipes 146 may be crimped downward (as viewed in FIG. 4). Along the fourth main circumferential groove 40, the angled sipes 146 may be crimped upward (as viewed in FIG. 4) and the shoulder sipes 156 may be crimped downward (as viewed in FIG. 4). The chamfers 118, 128, 138, 148, 158 and steps 119, 129, 139, 149, 159 may enhance the tread 100 with improved stiffness and a more uniform footprint pressure distribution.

While the present invention has been described in connection with what is considered the most practical example, it is to be understood that the present invention is not to be limited to the disclosed arrangements, but is intended to cover various arrangements which are included within the spirit and scope of the broadest possible interpretation of the appended claims so as to encompass all possible modifications and equivalent arrangements.

What is claimed:

1. A pneumatic tire comprising:
i. a first circumferential groove extending in a circumferential direction of the pneumatic tire;
ii. a second circumferential groove extending in the circumferential direction of the pneumatic tire;
iii. a third circumferential groove extending in the circumferential direction of the pneumatic tire; and
iv. a fourth circumferential groove extending in the circumferential direction of the pneumatic tire, the first, second, third, and fourth circumferential grooves defining first, second, third, fourth, and fifth ribs, each of the ribs including lateral grooves and lateral sipes, the lateral grooves of the first rib each having chamfers on an upper side at an intersection with the first circumferential groove.

2. The pneumatic tire as set forth in claim 1 wherein the lateral grooves of the second rib each have chamfers on a lower side at an intersection with the first circumferential groove, the lower side of the second rib being circumferentially opposite the upper side of the first rib.

3. The pneumatic tire as set forth in claim 2 wherein the lateral grooves of the second rib each have chamfers on an upper side at an intersection with the second circumferential groove, the upper side of the second rib being circumferentially opposite the lower side of the second rib.

4. The pneumatic tire as set forth in claim 3 wherein the lateral grooves of the third rib each have chamfers on an upper side at an intersection with the second circumferential groove, the upper side of the third rib being circumferentially equivalent to the upper side of the second rib.

5. The pneumatic tire as set forth in claim 4 wherein the lateral grooves of the third rib each have chamfers on a lower side at an intersection with the third circumferential groove, the lower side of the third rib being circumferentially opposite the upper side of the third rib.

6. The pneumatic tire as set forth in claim 5 wherein the lateral grooves of the fourth rib each have chamfers on a lower side at an intersection with the third circumferential groove, the lower side of the fourth rib being circumferentially equivalent the lower side of the third rib.

7. The pneumatic tire as set forth in claim 6 wherein the lateral grooves of the fourth rib each have chamfers on an upper side at an intersection with the fourth circumferential groove, the upper side of the fourth rib being circumferentially opposite the lower side of the fourth rib.

8. The pneumatic tire as set forth in claim 7 wherein the lateral grooves of the fifth rib each have chamfers on a lower side at an intersection with the fourth circumferential groove, the lower side of the fifth rib being circumferentially opposite the upper side of the fourth rib.

9. A tread for a pneumatic tire comprising:
v. a first circumferential groove extending in a circumferential direction of the pneumatic tire;
vi. a second circumferential groove extending in the circumferential direction of the pneumatic tire;
vii. a third circumferential groove extending in the circumferential direction of the pneumatic tire; and
viii. a fourth circumferential groove extending in the circumferential direction of the pneumatic tire, the first, second, third, and fourth circumferential grooves defining first, second, third, fourth, and fifth ribs, each of the ribs including lateral grooves and lateral sipes extending across each rib, the lateral grooves of the first rib each having chamfers on an upper side at an intersection with the first circumferential groove, the lateral sipes of the third rib each having crimped portions both where the sipes intersect the second groove and where the sipes intersect the third groove.

10. The tread as set forth in claim 9 wherein the lateral grooves of the second rib each have chamfers on a lower side at an intersection with the first circumferential groove, the lower side of the second rib being circumferentially opposite the upper side of the first rib.

11. The tread as set forth in claim 9 wherein the lateral grooves of the second rib each have chamfers on an upper side at an intersection with the second circumferential groove, the upper side of the second rib being circumferentially opposite a lower side of the second rib.

12. The tread as set forth in claim 9 wherein the lateral grooves of the third rib each have chamfers on an upper side at an intersection with the second circumferential groove, the upper side of the third rib being circumferentially equivalent to an upper side of the second rib.

13. The tread as set forth in claim 9 wherein the lateral grooves of the third rib each have chamfers on a lower side at an intersection with the third circumferential groove, the lower side of the third rib being circumferentially opposite an upper side of the third rib.

14. The tread as set forth in claim 9 wherein the lateral grooves of the fourth rib each have chamfers on a lower side at an intersection with the third circumferential groove, the lower side of the fourth rib being circumferentially equivalent a lower side of the third rib.

15. The tread as set forth in claim 9 wherein the lateral grooves of the fourth rib each have chamfers on an upper side at an intersection with the fourth circumferential groove, the upper side of the fourth rib being circumferentially opposite a lower side of the fourth rib.

16. The tread as set forth in claim 9 wherein the lateral grooves of the fifth rib each have chamfers on a lower side at an intersection with the fourth circumferential groove, the lower side of the fifth rib being circumferentially opposite an upper side of the fourth rib.

17. The tread as set forth in claim 9 wherein each of the lateral sipes of both the first and fifth ribs are blind sipes.
